(19) United States
(12) Patent Application Publication
(10) Pub. No.: US 2014/0118324 A1
(43) Pub. Date: May 1, 2014

(54) DISPLAY APPARATUS, DRIVING MODULE THEREOF, VOLTAGE CONTROL CIRCUIT AND VOLTAGE CONTROL METHOD

(71) Applicant: AU OPTRONICS CORP., Hsin-Chu (TW)

(72) Inventors: Pin-Yu CHAN, Hsin-Chu (TW); Chih-Che HSU, Hsin-Chu (TW); Yung-Chih CHEN, Hsin-Chu (TW); Ming-Yen TSAI, Hsin-Chu (TW)

(21) Appl. No.: 13/937,342

(22) Filed: Jul. 9, 2013

(30) Foreign Application Priority Data
Nov. 1, 2012 (TW) 101140599

(51) Int. Cl. G09G 5/00

(52) U.S. Cl. CPC G09G 5/001
USPC 345/212

(57) ABSTRACT

A voltage control circuit used to control a first clock signal received by a gate driver array of a display apparatus is provided. The voltage control circuit includes a gate trigger pulse generator unit and a controller. The gate trigger pulse generator unit receives a reference voltage and a driving signal outputted from the gate driver array, and accordingly generate a gate trigger pulse; wherein a pulse width of the gate trigger pulse is controlled according to a level relationship between the driving signal and the reference voltage. The controller, coupled to the gate trigger pulse generator unit, receives the gate trigger pulse and control a potential difference of a pulse level of the first clock signal according to the pulse width of the gate trigger pulse. A voltage control method, a driving module of a display apparatus and a display apparatus are also provided.

### TECHNICAL FIELD

The present disclosure relates to display apparatus, driving module thereof, voltage control circuit and voltage control method, and more particularly to display apparatus, driving module thereof, voltage control circuit and voltage control method for compensating operating voltages of a gate driver array.

### BACKGROUND

FIG. 1 is a block view of a conventional liquid crystal display apparatus. As shown, the conventional liquid crystal display apparatus 100 includes a glass substrate 102 and a printed circuit board 104; wherein the printed circuit board 104 is coupled to the glass substrate 102 via a flexible substrate 106.

The glass substrate 102 has a display area 112 and two gate driver on arrays (GOAs) 114 and 116. The display area 112 includes a plurality of gate lines 118 and a plurality of source lines 120, which are arranged to each other in a sequential and intersectional manner. A liquid crystal unit 122, served as a pixel cell, is disposed at each intersectional point of the gate lines 118 and the source lines 120; and accordingly the liquid crystal units 122 are arranged in a matrix manner. In addition, each liquid crystal unit 122 is coupled to the corresponding gate line 118 and source line 120 via a thin film transistor 124.

The gate driver on arrays 114 and 116 are coupled to the display area 112 via the gate lines 118 and configured to generate a plurality of scanning signals (not shown) according to an operating voltage. The scanning signals are transmitted to the gate lines 118 and thereby turning on the thin film transistors 124 coupled to the gate lines 118. However, when the liquid crystal display apparatus 100 is operated in a relatively-low temperature, the output currents of the thin film transistors 124 may drop substantially and consequently the liquid crystal display apparatus 100 may not be able to display images normally.

Specifically, the aforementioned issue is getting more serious if the gate driver on arrays 114 and 116 are directly manufactured on the glass substrate 102 by the GOA technical rather than employing an external integrated driving circuit.

In order to solve the above issue, conventionally the printed circuit board 104 is disposed with a temperature sensor 130 thereon. Thus, The gate driver on arrays 114 and 116 can have the potential levels of the operating voltages thereof raised up if the temperature sensor 130 senses that the environmental temperature is lower than a threshold degree, and consequentially the liquid crystal display apparatus 100 still can display images normally in a relatively-low temperature.

### SUMMARY

The present disclosure provides voltage control circuit and voltage control method for compensating the operating voltage of the gate driver array of the display apparatus. Thus, the display apparatus can display images normally in different temperatures.

The present disclosure further provides a driving module of a display apparatus. The driving module is capable of driving the display apparatus to display images normally in different temperatures.

The present disclosure still provides a display apparatus capable of displaying images normally in different temperatures.

An embodiment of the disclosure provides a voltage control circuit adapted to be used to control a first clock signal received by a gate driver array of a display apparatus. The voltage control circuit includes a gate trigger pulse generator unit and a controller. The gate trigger pulse generator unit is configured to receive a reference voltage and one of a plurality of driving signals outputted from the gate driver array and accordingly generate a gate trigger pulse, wherein a pulse width of the gate trigger pulse is controlled by the gate trigger pulse generator unit according to a potential-level relationship between the received driving signal and the reference voltage. The controller, coupled to the gate trigger pulse generator unit, is configured to receive the gate trigger pulse and control a potential difference of a pulse level of the first clock signal according to the pulse width of the gate trigger pulse.

Another embodiment of the disclosure provides a driving module of a display apparatus. The display apparatus includes a plurality of pixel rows arranged in a sequence and each pixel row includes a plurality of pixels. The driving module includes a gate driver array, a voltage control circuit and an operating voltage generator circuit. The gate driver array is coupled to the pixel rows and configured to receive a first clock signal and output a plurality of driving signals in a sequence to drive the pixel rows, respectively. The voltage control circuit is coupled to the gate driver array and configured to control a potential difference of a pulse level of the first clock signal. The voltage control circuit includes a gate trigger pulse generator unit and a controller. The gate trigger pulse generator unit is configured to receive a reference voltage and one of a plurality of driving signals outputted from the gate driver array and accordingly generate a gate trigger pulse, wherein a pulse width of the gate trigger pulse is controlled by the gate trigger pulse generator unit according to a potential-level relationship between the received driving signal and the reference voltage. The controller is coupled to the gate trigger pulse generator unit and configured to receive the gate trigger pulse and output a control voltage according to the pulse width of the gate trigger pulse thereby controlling the potential difference of a pulse level of the first clock signal. The operating voltage generator circuit is coupled to the gate driver array and configured to provide the first clock signal and adjust the first clock signal according to the control signal.

Still another embodiment of the disclosure provides a display apparatus, which includes a substrate, a plurality of gate lines, a gate driver array, an operating voltage generator circuit and a voltage control circuit. The substrate includes a display area. The display area includes a plurality of pixel rows arranged in a sequence. Each pixel row includes a plurality of pixels. The gate lines are respectively coupled to the pixels of the respective pixel rows. The gate driver array is configured to receive a first clock signal. The gate driver array includes a plurality of series-coupled driving shift registers and at least one dummy shift register. The series-coupled driving shift registers are coupled to the gate lines respectively and configured to sequentially output a first driving signal to the respective gate lines according to the first clock signal and thereby turning on the pixels coupled to the gate lines. The dummy shift register is coupled to the last-stage driving shift register of the driving shift registers and configured to receive the first driving signal from the last-stage driving shift register and generate a second driving signal. The operating voltage generator circuit is coupled to the gate driver array and configured to provide the first clock signal. The voltage control circuit, coupled to the dummy shift register and the operating voltage generator circuit, is configured to control a potential difference of a pulse level of the first clock signal according to a potential-level relationship between a reference voltage and either one of the first driving signals or one of the second driving signals.

Yet another embodiment of the disclosure provides a voltage control method adapted to be used to control a first clock signal of a gate driver array of a display apparatus. The voltage control method includes steps of: receiving a driving signal outputted from the gate driver array and generating a gate trigger pulse according to the received driving signal; controlling a pulse width of the gate trigger pulse according to a potential-level relationship between the driving signal and a reference voltage; and controlling a potential difference of a pulse level of the first clock signal according to the pulse width of the gate trigger pulse.

In summary, by monitoring the driving signals outputted from the gate driver array of the display apparatus, the present invention can dynamically adjust the potential difference of the pulse level of the first clock signal in time. In addition, by directly disposing the voltage control circuit on either the glass substrate or the printed circuit board, the present invention can have lower hardware cost.

### BRIEF DESCRIPTION OF THE DRAWINGS

The present disclosure will become more readily apparent to those ordinarily skilled in the art after reviewing the following detailed description and accompanying drawings, in which:

FIG. 1 is a block view of a conventional liquid crystal display apparatus;

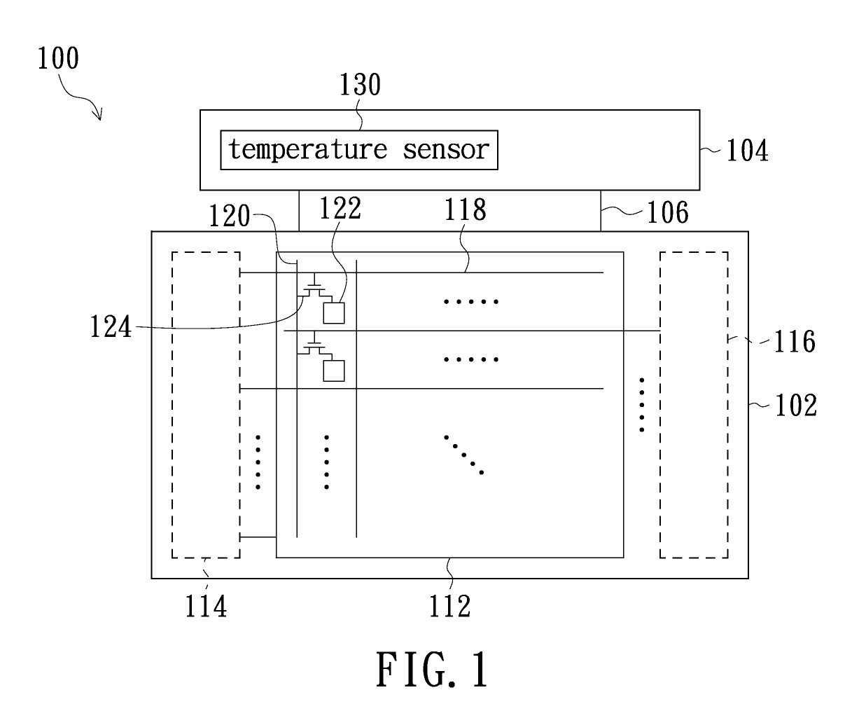

FIG. 2A is a block view of a display apparatus in accordance with an embodiment of the present disclosure;

FIG. 2B is a schematic waveform view of the potential difference between the logic-high and logic-low voltage levels of the first clock signal VCK;

FIG. 3A is a block view of the gate driver array shown in FIGS. 2 and 9 in accordance with an embodiment of the present disclosure;

FIG. 3B is an alternative block view of the gate driver array shown in FIGS. 2 and 9 in accordance with another embodiment of the present disclosure;

FIG. 4 is a schematic circuit view of the shift register shown in FIG. 3B;

FIG. 5 is a schematic timing sequence diagram of the signals associated with the driving shift register shown in FIG. 4;

FIG. 6 is a schematic block view of the voltage control circuit shown in FIGS. 2A and 8;

FIG. 7 is a schematic waveform diagram of the signals associated with the voltage control circuit shown in FIG. 6;

FIG. 8 is a schematic timing sequence diagram of the signals associated with the voltage control circuit shown in FIG. 6;

FIG. 9 is a block view of a display apparatus in accordance with another embodiment of the present disclosure; and

FIGS. 10A and 10B are flowcharts illustrating a voltage control method in accordance with an embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

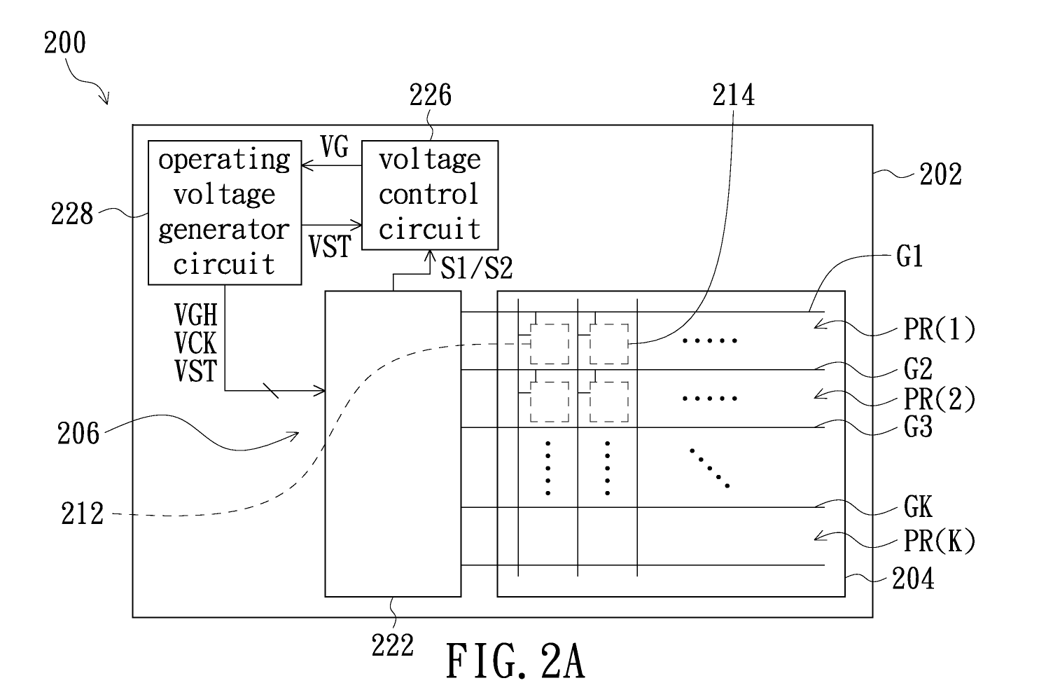

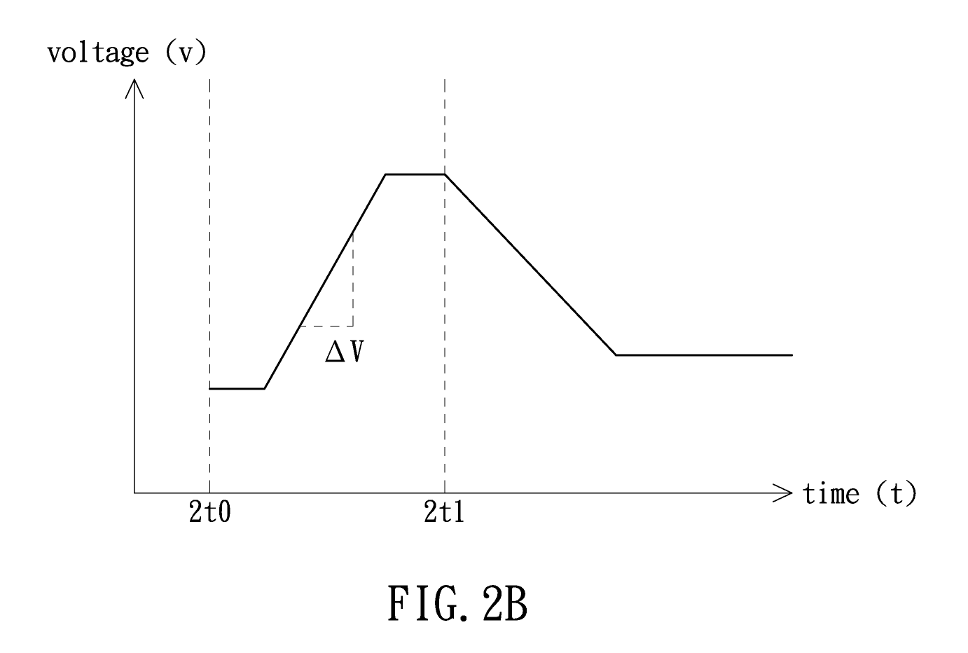

FIG. 2A is a block view of a display apparatus in accordance with an embodiment of the present disclosure. As shown, the display apparatus 200 in this embodiment includes a substrate 202, which might be a glass substrate and the present disclosure is not limited thereto. The display apparatus 200 is disposed with a display area 204 and a driving module 206 thereon; wherein some components of the driving module 206 are not necessarily to be disposed on the substrate 202 in an embodiment.

The display area 204 has a plurality of pixel rows PR(1), PR(2), . . . , PR(K) arranged in a sequence; where K is a positive integer. In addition, the pixel rows PR(1), PR(2), . . . , PR(K) each are corresponding to at least one gate line. In this embodiment, the pixel rows PR(1), PR(2), . . . , PR(K) are corresponding to the gate lines G1, G2, . . . , GK, respectively. The pixel rows PR(1), PR(2), . . . , PR(K) each include a plurality of pixels (herein only two exemplary pixels 212 and 214 are shown) arranged in a sequence. The gate lines G1, G2, . . . , GK each are coupled to all the pixels in the respective pixel row.

The driving module 206 includes a gate driver array 222, a voltage control circuit 226 and an operating voltage generator circuit 228; wherein the gate driver array 222 is specifically called a gate driver on array (GOA) if being disposed on the substrate 202. In this embodiment, the operating voltage generator circuit 228 is configured to output a first clock signal VCK and/or a start signal VST; wherein the functions of the two signals VCK and VST will be described in detail later. In addition, the operating voltage generator circuit 228 is further configured to control the potential difference of the pulse level of the first clock signal VCK and/or the start signal VST according to a control voltage VG outputted from the voltage control circuit 226.

FIG. 2B is a schematic waveform view of the potential difference between the logic-high and logic-low voltage levels of the first clock signal VCK. As shown, after the display apparatus 200 is being booted at time point 2t0, the potential difference of the pulse level of the first clock signal VCK starts to gradually increase, from the logic-low voltage level, by an incremental ratio ΔV with time. Then, after the display apparatus 200 is booted completely at time point 2t1, the potential difference of the pulse level of the first clock signal VCK starts to gradually decrease, from the logic-high voltage level, with time. It is understood that the actual voltage variation may vary based on the current operating situation of the display apparatus 200. Thus, the first clock signal VCK can have the potential difference of the pulse level thereof modulated according to the pulse width of the gate trigger pulse, rather than having the two logic-high and logic-low states only.

Please refer back to FIG. 2A. In response to a specific circuit design of the gate driver array 222, the operating voltage generator circuit 228 may be further configured to output an operating voltage VGH to the gate driver array 222; wherein the operating voltage VGH herein is used to drive the shift registers (not shown) in the gate driver array 222. It is understood that the operation voltage VGH may be omitted if the gate driver array 222 with another circuit architecture is adopted.

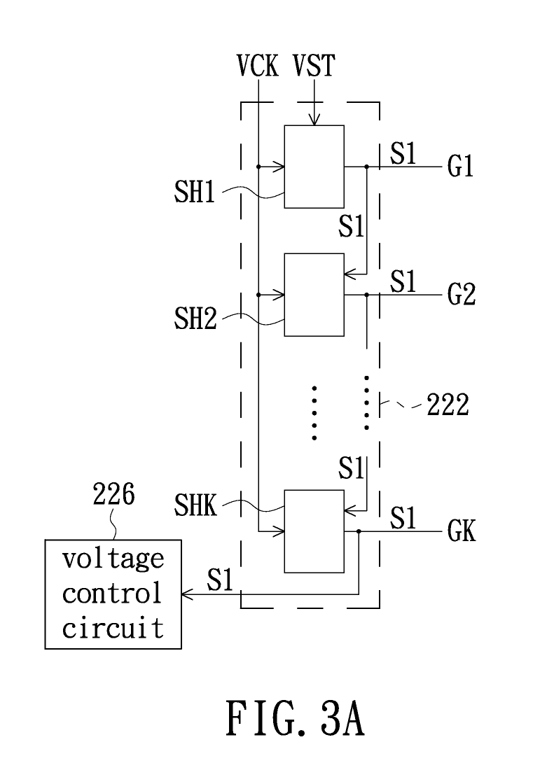

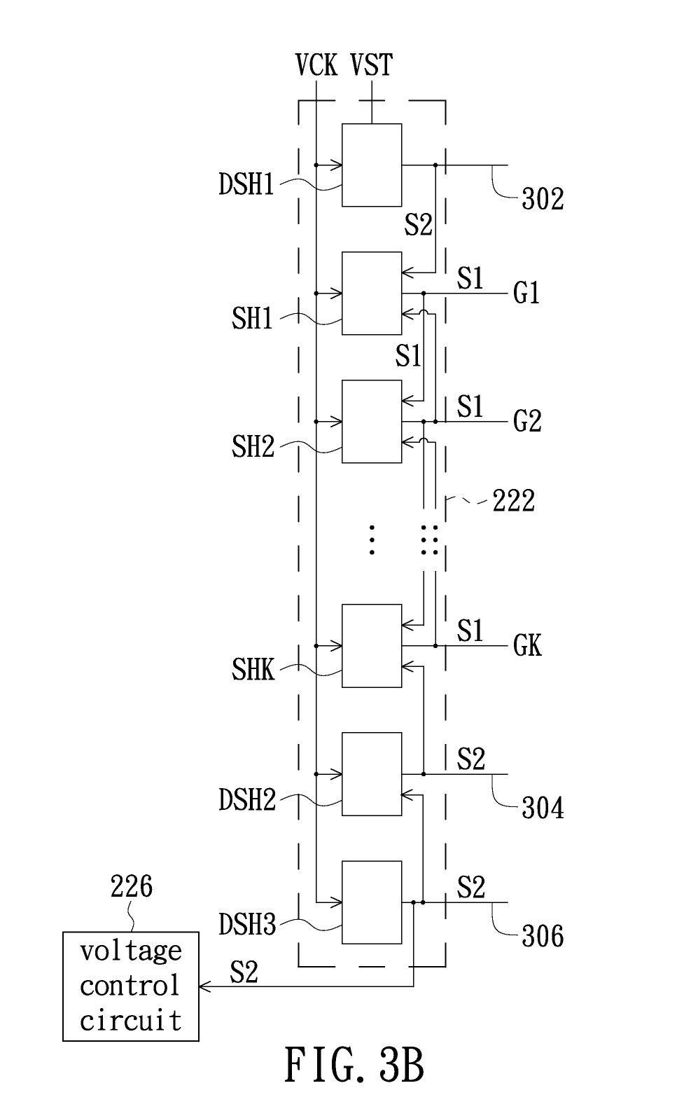

FIG. 3A is a block view of the gate driver array 222 in accordance with an embodiment of the present disclosure. Please refer to FIGS. 2A and 3A both. As shown, the gate driver array 222 in this embodiment includes a plurality of serially-connected driving shift registers SH1, SH2, . . . , SHK, which are coupled to the gate lines G1, G2, . . . , GK, respectively. The driving shift registers SH1, SH2, . . . , SHK are configured to receive the first clock signal VCK and the start signal VST from the operating voltage generator circuit 228 and output, according to the received first clock signal VCK and the start signal VST, a first driving signal S1 (hereafter also referred to as a scanning signal S1) to the gate lines G1, G2, . . . , GK, respectively, and thereby sequentially turning on the pixels coupled to the gate lines G1, G2, . . . , GK. In an embodiment, the first driving signal S1 outputted from the last-stage driving shift register SHK is further transmitted to the voltage control circuit 226.

FIG. 3B is an alternative block view of the gate driver array 222 in accordance with another embodiment of the present disclosure. As shown, each driving shift register is further, beside the corresponding gate line Gn, coupled to the previous-stage gate line Gn−1 and the next-stage gate line Gn+1. For example, the driving shift register SH2 is coupled to the gate lines G1, G2 and G3. The gate driver array 222 in this embodiment further includes two dummy gate lines 302 and 304 located close to the first-stage driving shift register SH1 and the last-stage driving shift register SHK, respectively. It is to be noted that the number of the dummy gate lines can be adjusted according to the circuit structures of the driving shift registers SH1, SH2, . . . , SHK. For example, beside the dummy gate line 304, the gate driver array 222 in this embodiment may further include a dummy gate line 306 located close to the last-stage driving shift register SHK. In addition, the dummy gate lines 302, 304 and 306 are not coupled to any pixel unit.

As shown in FIG. 3B, the gate driver array 222 in this embodiment further includes dummy shift register DSH1, DSH2 and DSH3 coupled to the dummy gate lines 302, 304 and 306, respectively. Basically, the signal output from each one of the dummy shift registers DSH1, DSH2 and DSH3 is used to drive the driving shift registers SH1, SH2, . . . , SHK. Specifically, the dummy shift register DSH1, DSH2 and DSH3 each are configured to output a second driving signal S2 (hereafter also referred to as a dummy scanning signal S2) to drive either the first-stage driving shift register SH1 or the last-stage driving shift register SHK. In this embodiment, the second driving signal S2 outputted from the last-stage dummy shift register DSH3 is further transmitted to the voltage control circuit 226.

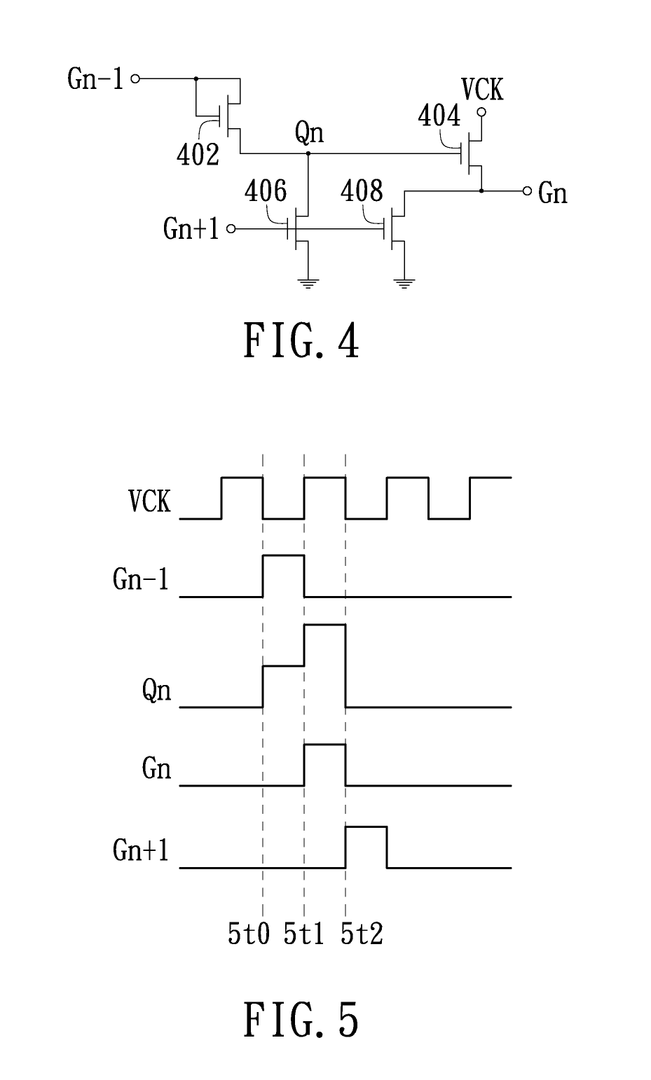

FIG. 4 is a schematic circuit view of the shift register shown in FIG. 3B. As shown, the driving shift registers SH1, SH2, . . . , SHK and the dummy shift register DSH1, DSH2 and DSH3 each include transistors 402, 404, 406 and 408. The shift register shown in FIG. 4 is exemplified by being corresponding to the gate line Gn. The transistor 402 is configured to have the gate end and the first end (e.g., the source end) thereof together coupled to the previous-stage gate line Gn−1, and the second end (e.g. the drain end) thereof coupled to the gate end of the transistor 404 and the first end of the transistor 406.

The transistor 404 is configured to have the first end thereof for receiving the first clock signal VCK, the second end thereof coupled to the gate line Gn and the first end of the transistor 408. The transistors 406 and 408 each are configured to have the gate end thereof coupled to the next-stage gate lines Gn+1 and the second end thereof grounded. In an embodiment, the transistors 402, 404, 406 and 408 each is implemented by an NMOS transistor; and the present invention is not limited thereto. It is to be noted that the driving signal on the gate line Gn is generated based on the first clock signal VCK and either the signal on the previous-stage gate line Gn−1 or the start signal VST; accordingly, each shift register can have a specific output waveform by adjusting the potential differences of the pulse levels of the first clock signal VCK and the start signal VST.

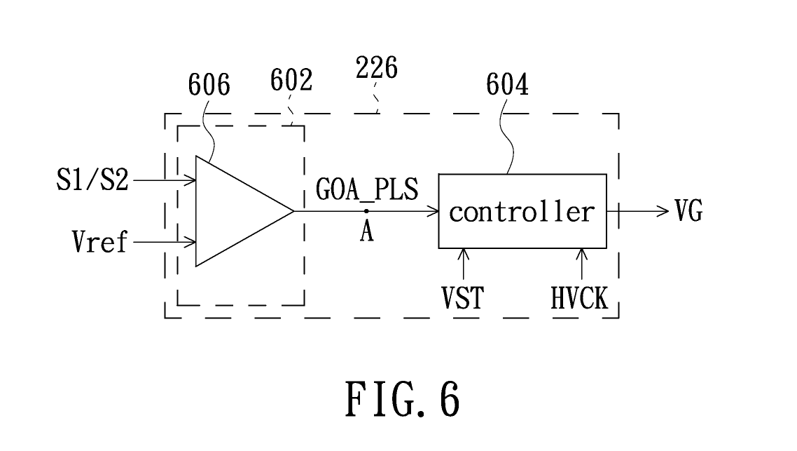

FIG. 5 is a schematic timing sequence diagram of the signals associated with the driving shift register shown in FIG. 4. Please refer to FIGS. 4 and 5 both. Within the period between time points 5t0 and 5t1, the transistors 402 and 404 both are turned on by the logic-high potential on the previous-stage gate line Gn−1; and accordingly the node Qn is charged to have a first potential by the current flowing through the turned-on transistor 402 within the same period. Within the same period between time points 5t0 and 5t1, the transistors 406 and 408 are turned off by the logic-low potential on the next-stage gate line Gn+1. Thus, via the turned-on transistor 404, the gate line Gn has a potential thereon same as the first clock signal VCK has (logic-low potential) within the same period between time points 5t0 and 5t1.

Within the period between time points 5t1 and 5t2, the transistor 402 is turned off by the logic-low potential on the previous-stage gate line Gn−1; however, the transistor 404 is still turned-on due to the node Qn is maintained at the first potential. Accordingly, the node Qn is further charged to have a second potential by the current, derived from the logic-high first clock signal VCK, flowing through the turned-on transistor 404 within the same period. Thus, via the turned-on transistor 404, the second end of the transistor 404 is switched to have the logic-high potential by the logic-high first clock signal VCK so as to result in the first driving signal S1 on the gate line Gn. Within the same period between time points 5t1 and 5t2, the transistors 406 and 408 are still turned off by the logic-low potential on the next-stage gate line Gn+1.

After the time point 5t2, the transistors 406 and 408 both are turned on by the logic-high potential on the previous-stage gate line Gn+1; accordingly, the node Dn and the second end of the transistor 404 are discharged by the turned-on transistors 406 and 408, respectively. Eventually, the transistor 404 will be turned off and the gate line Gn is switched to have a logic-low potential thereon and thereby completing one work cycle of the first driving signal S1.

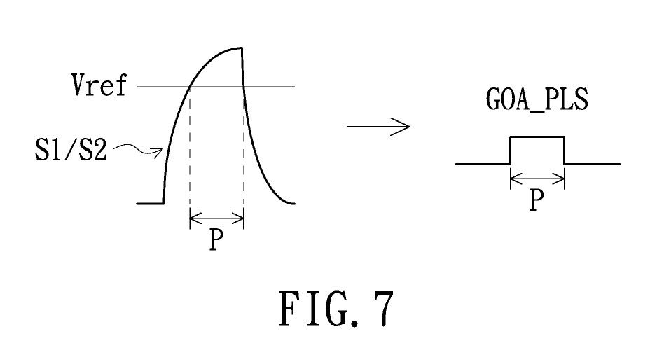

FIG. 6 is a schematic block view of the voltage control circuit 226 shown in FIG. 2A. Please refer to FIGS. 2 and 6 both. As shown, the voltage control circuit 226 in this embodiment includes a gate trigger pulse generator unit 602 and a controller 604. The gate trigger pulse generator unit 602 may be coupled to the driving shift register SHK shown in FIG. 3A or either the dummy shift registers DSH2 or DSH3 shown in FIG. 3B, and thereby being configured to receive the first driving signal S1/the second driving signal S2. Furthermore, the gate trigger pulse generator unit 602 is further configured to receive a reference voltage Vref. Thus, the gate trigger pulse generator unit 602 can be further configured to output a gate trigger pulse GOA_PLS to the controller 604 according to a voltage level relationship between the reference voltage Vref and the first driving signal S1/the second driving signal S2.

In one embodiment, the gate trigger pulse generator unit 602 may be implemented by a comparator 606 as illustrated in FIG. 6; wherein the comparator 606 is configured to have the first end (e.g. the positive end) thereof for receiving the first driving signal S1/the second driving signal S2, and the second input end (e.g., the negative end) thereof for receiving the reference voltage Vref. Thus, the comparator 606 can be further configured to output the gate trigger pulse GOA_PLS to the controller 604 by comparing the first driving signal S1/the second driving signal S2 with the reference voltage Vref. The controller 604, when receiving the gate trigger pulse GOA_PLS, is configured to output the control voltage VG to the operating voltage generator circuit 228 (FIG. 2A) according to the pulse width of the received gate drive pulse GOA_PLS, and thereby controlling the operating voltage generator circuit 228 to determine the voltage levels of the start signal VST, the first time signal VCK and/or the operating voltage VGH.

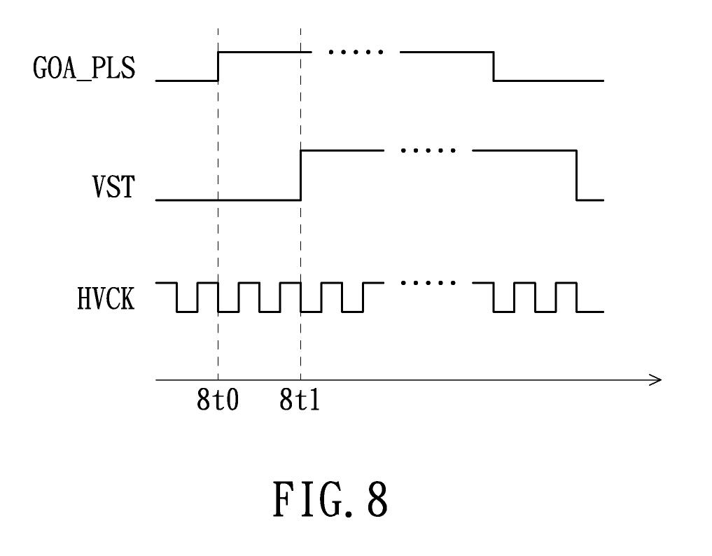

FIG. 7 is a schematic waveform diagram of the signals associated with the voltage control circuit 226 shown in FIG. 6. Please refer to FIGS. 6 and 7 both. As shown, the comparator 606 first compares the first driving signal S1/the second driving signal S2 with the reference voltage Vref after obtaining the first compares the first driving signal S1/the second driving signal S2. Specifically, the gate trigger pulse GOA_PLS outputted from the output end A of the comparator 606 has a logic-low level if the first driving signal S1/the second driving signal S2 has a potential level lower than that of the reference voltage Vref. Alternatively, the gate trigger pulse GOA_PLS outputted from the output end A of the comparator 606 has a logic-high level if the first driving signal S1/the second driving signal S2 has a potential level higher than that of the reference voltage Vref.

As shown in FIG. 7, the portion of the first driving signal S1/the second driving signal S2 having a potential level greater than the reference voltage Vref has a pulse width P, which is also referred to as the duty cycle (pulse width) of the gate trigger pulse GOA_PLS. In other words, the gate trigger pulse generator unit 602 can determine the pulse width of the gate trigger pulse GOA_PLS according to a potential level relationship between the first driving signal S1/the second driving signal S2 and the reference voltage Vref. For example, the aforementioned potential level relationship is associated with the time of the first driving signal S1/the second driving signal S2 having a voltage level greater than the reference voltage Vref.

Please refer to FIG. 6 again. In an embodiment, the controller 604 is further configured to receive a second clock signal HVCK, which is configured to have a frequency higher than that of the first clock signal VCK. Thus, the controller 604 can calculate the pulse width of the gate trigger pulse GOA_PLS by using the second clock signal HVCK. In another embodiment, the controller 604 is further configured to receive a start signal VST; and the display apparatus 100 starts to display (or update) a frame image when the controller 604 detects an enabled start signal VST. In addition, the start signal VST is further used to trigger the gate driver array 222 thereby configuring the driving shift registers SH1, SH2, . . . , SHK and the dummy shift register DSH1, DSH2 and DSH3 to output respective pulses.

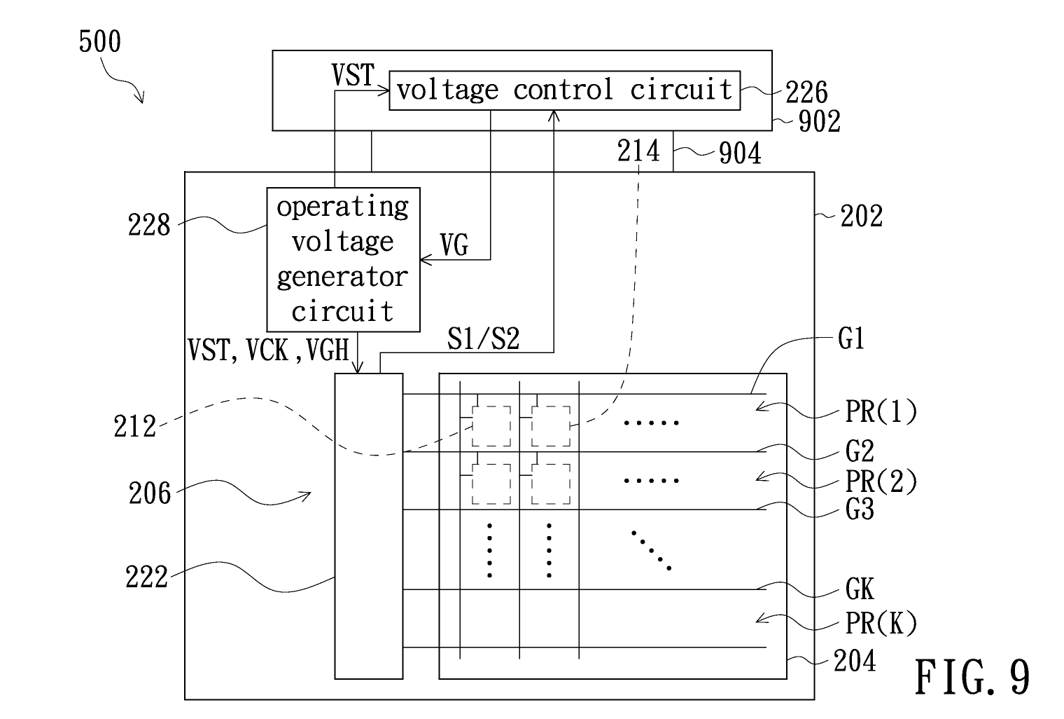

FIG. 8 is a schematic timing sequence diagram of the signals associated with the voltage control circuit 226 shown in FIG. 6. Please refer to FIGS. 6 and 8 both. At the time point 8t0, the gate trigger pulse generator unit 602 is configured to output, via the output end A thereof, the gate trigger pulse GOA_PLS to the controller 604. The gate trigger pulse GOA_PLS is then latched by the controller 604 until the start signal VST is enabled at the time point 8t1.

Specifically, the controller 604, when detecting an enabled start signal VST, is configured to calculate the pulse width of the gate trigger pulse GOA_PLS by using the second clock signal HVCK. In other words, by calculating the number of the second clock signal HVCK within the working period of the gate trigger pulse GOA_PLS, the controller 604 can calculate the pulse width of the gate trigger pulse GOA_PLS, and accordingly determine the potential levels of the start signal VST, the first clock signal VCK and/or the operating voltage VGH. Briefly, by dynamically modulating the potential levels of the start signal VST, the first clock signal VCK and/or the operating voltage VGH within each frame time, the gate trigger pulse GOA_PLS in this frame time can be configured to have a specific pulse width; wherein the pulse width of the gate trigger pulse GOA_PLS is associated with a relationship between the first driving signal S1/the second driving signal S2 and the reference voltage Vref.

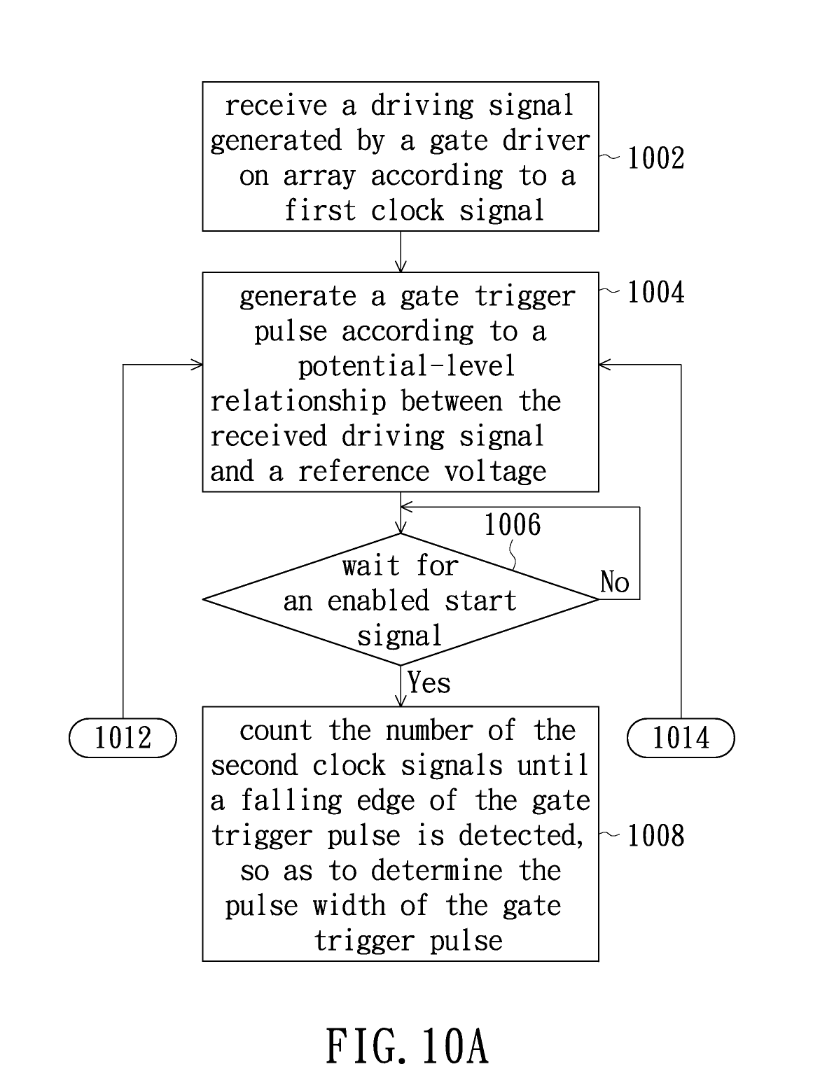

FIG. 9 is a block view of a display apparatus in accordance with another embodiment of the present disclosure. As shown, the display apparatus 500 in this embodiment is similar to the display apparatus 200 shown in FIG. 2; and the main difference between the two is that the display apparatus 500 further includes a printed circuit board 902, which is coupled to the substrate 202 through a flexible circuit board 904. In this embodiment, the voltage control circuit 226 may be disposed on the printed circuit board 902. The way of modulating the potential difference of the pulse level of the first clock signal VCK is similar to that described in FIG. 2A; and no redundant detail is to be given herein. In addition, to get a clear understanding of the functions of the components in the display apparatus 500, please refer to the corresponding descriptions in FIGS. 3A, 3B, 4 and 6.

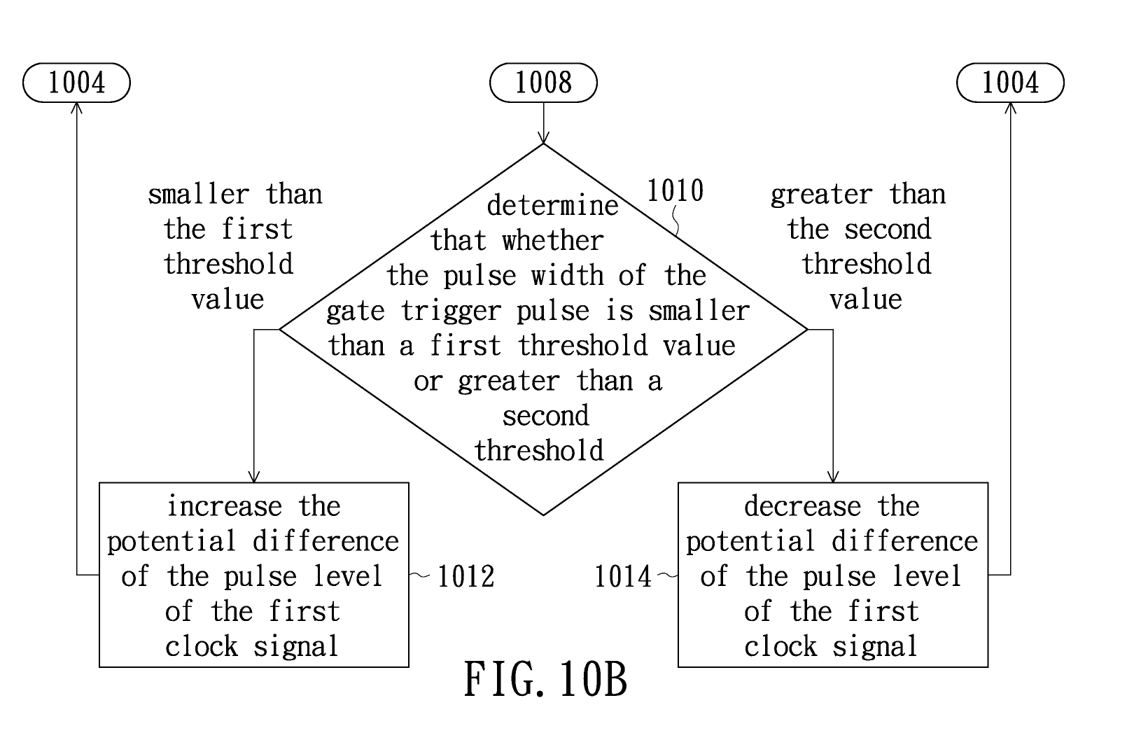

FIGS. 10A and 10B are flowcharts illustrating a voltage control method in accordance with an embodiment of the present disclosure; wherein the voltage control method in this embodiment is adapted to be used for the display apparatus shown in FIG. 2 or 9. As shown in FIGS. 10A and 10B, first, the voltage control method receives a plurality of driving signals generated by a gate driver array of the display apparatus according to a first clock signal VCK (step 1002). Next, the method generates a gate trigger pulse GOA_PLS according to a potential-level relationship between one of the received driving signals and a reference voltage (step 1004). Next, the voltage control method waits for an enabled start signal (step 1006).

When an enabled start signal is detected, the voltage control method starts to count the number of the second clock signals HVCK of the display apparatus until a falling edge of the gate trigger pulse GOA_PLS is detected, so as to determine the pulse width of the gate trigger pulse GOA_PLS (step 1008). Thus, the method can control the potential difference of the pulse level of the first clock signal VCK according to the length of the gate trigger pulse GOA_PLS.

After the pulse width of the gate trigger pulse GOA_PLS is calculated, the voltage control method determines that whether the pulse width of the gate trigger pulse GOA_PLS is smaller than a first threshold value or greater than a second threshold value (step 1010). If the display apparatus is operated in a relatively-low-temperature environment which is indicated by that the pulse width of the gate trigger pulse GOA_PLS is smaller than the first threshold value, the voltage control method increases the potential difference of the pulse level of the first clock signal VCK (step 1012), so as to make the display apparatus still have normal functions in a relatively-low-temperature environment. It is to be noted that the potential difference of the pulse level of the first clock signal VCK may have a multi-segmented modulation with a decreasing of temperature. The method moves to step 1014 after the step 1012 is completed.

In step 1010, alternatively, if the display apparatus is operated in a relatively-high-temperature environment which is indicated by that the pulse width of the gate trigger pulse GOA_PLS is greater than the second threshold value, the voltage control method decreases the potential difference of the pulse level of the first clock signal VCK (step 1014), so as to make the display apparatus still have normal functions in a relatively-high-temperature environment.

In summary, by monitoring the driving signals outputted from the gate driver array of the display apparatus, the present invention can dynamically adjust the potential difference of the pulse level of the first clock signal in time. In addition, by directly disposing the voltage control circuit on either the glass substrate or the printed circuit board, the present invention can have lower hardware cost.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A voltage control circuit adapted to be used to control a first clock signal received by a gate driver array of a display apparatus, the voltage control circuit comprising:
a gate trigger pulse generator unit configured to receive a reference voltage and one of a plurality of driving signals outputted from the gate driver array and accordingly generate a gate trigger pulse, wherein a pulse width of the gate trigger pulse is controlled by the gate trigger pulse generator unit according to a potential-level relationship between the received driving signal and the reference voltage; and
a controller, coupled to the gate trigger pulse generator unit, configured to receive the gate trigger pulse and control a potential difference of a pulse level of the first clock signal according to the pulse width of the gate trigger pulse.

2. The voltage control circuit according to claim 1, wherein the controller is further configured to receive a second clock signal in the display apparatus and calculate the pulse width of the gate trigger pulse by using the second clock signal, wherein the second clock signal is configured to have a frequency greater than that of the first clock signal.

3. The voltage control circuit according to claim 2, wherein the potential difference of the pulse level of the first clock signal is modulated gradually according to the pulse width of the gate trigger pulse.

4. The voltage control circuit according to claim 3, wherein the gate trigger pulse generator unit comprises a comparator configured to generate the gate trigger pulse by comparing the received driving signal with the reference voltage.

5. The voltage control circuit according to claim 2, wherein the gate trigger pulse generator unit comprises a comparator configured to generate the gate trigger pulse by comparing the received driving signal with the reference voltage.

6. The voltage control circuit according to claim 1, wherein the potential difference of the pulse level of the first clock signal is modulated gradually according to the pulse width of the gate trigger pulse.

7. The voltage control circuit according to claim 1, wherein the gate trigger pulse generator unit comprises a comparator configured to generate the gate trigger pulse by comparing the received driving signal with the reference voltage.

8. The voltage control circuit according to claim 7, wherein the potential difference of the pulse level of the first clock signal is modulated gradually according to the pulse width of the gate trigger pulse.

9. A driving module of a display apparatus, the display apparatus comprising a plurality of pixel rows arranged in a sequence and each pixel row comprising a plurality of pixels, the driving module comprising:
a gate driver, coupled to the pixel rows, configured to receive a first clock signal and output a plurality of driving signals in a sequence to drive the pixel rows, respectively; and
a voltage control circuit, coupled to the gate driver array, configured to control a potential difference of a pulse level of the first clock signal, and the voltage control circuit comprising:
a gate trigger pulse generator unit configured to receive a reference voltage and one of a plurality of driving signals outputted from the gate driver array and accordingly generate a gate trigger pulse, wherein a pulse width of the gate trigger pulse is controlled by the gate trigger pulse generator unit according to a potential-level relationship between the received driving signal and the reference voltage; and
a controller, coupled to the gate trigger pulse generator unit, configured to receive the gate trigger pulse and output a control voltage according to the pulse width of the gate trigger pulse thereby controlling the potential difference of a pulse level of the first clock signal; and
an operating voltage generator circuit, coupled to the gate driver array, configured to provide the first clock signal and adjust the first clock signal according to the control signal.

10. The driving module according to claim 9, wherein the driving signals comprises a plurality of first driving signals and at least one second driving signal, the gate driver array comprises:
a plurality of driving shift registers configured to generate the first driving signals and supply the first driving signals to the respective pixel rows; and
at least one dummy shift register, coupled to the last-stage driving shift register of the driving shift registers and the gate trigger pulse generator unit, configured to generate the one or more second driving signals and supply the second driving signal to an input end of the gate trigger pulse generator unit.

11. A voltage control method adapted to be used to control a first clock signal of a gate driver array of a display apparatus, the voltage control method comprising:
receiving a driving signal outputted from the gate driver array and generating a gate trigger pulse according to the received driving signal;
controlling a pulse width of the gate trigger pulse according to a potential-level relationship between the driving signal and a reference voltage; and
controlling a potential difference of a pulse level of the first clock signal according to the pulse width of the gate trigger pulse.

12. The voltage control method according to claim 11, further, after receiving a driving signal outputted from the gate driver array and generating a gate trigger pulse according to the received driving signal and controlling a pulse width of the gate trigger pulse according to a potential-level relationship between the driving signal and a reference voltage, further comprising:
displaying, by the display apparatus, a frame image when detecting an enabled start signal; and
calculating the pulse width of the gate trigger pulse when detecting the enabled start signal.

13. The voltage control method according to claim 12, wherein controlling a potential difference of a pulse level of the first clock signal according to the pulse width of the gate trigger pulse comprises:
increasing the potential level of the first clock signal if the pulse width of the gate trigger pulse is smaller than a first threshold value; and
decreasing the potential level of the first clock signal if the pulse width of the gate trigger pulse is greater than a second threshold value.

14. The voltage control method according to claim 12, further comprising:
calculating the pulse width of the gate trigger pulse by using a second clock signal, wherein the second clock signal is configured to have a frequency greater than that of the first clock signal.

15. The voltage control method according to claim 14, wherein controlling a potential difference of a pulse level of the first clock signal according to the pulse width of the gate trigger pulse comprises:
increasing the potential level of the first clock signal if the pulse width of the gate trigger pulse is smaller than a first threshold value; and
decreasing the potential level of the first clock signal if the pulse width of the gate trigger pulse is greater than a second threshold value.

16. The voltage control method according to claim 11, further comprising:
calculating the pulse width of the gate trigger pulse by using a second clock signal, wherein the second clock signal is configured to have a frequency greater than that of the first clock signal.

17. The voltage control method according to claim 11, wherein controlling a potential difference of a pulse level of the first clock signal according to the pulse width of the gate trigger pulse comprises:
increasing the potential level of the first clock signal if the pulse width of the gate trigger pulse is smaller than a first threshold value; and
decreasing the potential level of the first clock signal if the pulse width of the gate trigger pulse is greater than a second threshold value.
